(19) United States
(12) Patent Application Publication
(10) Pub. No.: US 2012/0097615 A1
(43) Pub. Date: Apr. 26, 2012

(54) Method and Apparatus for De-Oiling Magnetic Solid Waste

(76) Inventor: Mohsen AMIRAN, Des Plaines, IL (US)

(21) Appl. No.: 12/911,697

(22) Filed: Oct. 25, 2010

(51) Int. Cl. B03C 1/30

(52) U.S. Cl. 210/695; 210/182

(57) ABSTRACT

Disclosed are a method and apparatus for treating oil-containing particulates such as mill sludge comprising applying a treatment solution to a particulate feed stream to form a treated slurry, applying a mechanical disrupter to the treated slurry to reduce an average particulate size, applying a magnetic separator to the treated slurry to form a ferrous slurry, and applying a thermal separator to the ferrous slurry to extract a hydrocarbon portion and produce a ferrous product stream. This basic method and the associated apparatus may be modified in a number of ways including, for example, applying a sizing operation to the oil-containing particulates to remove larger particles from the particulate feed stream, condensing a volume of the hydrocarbon portion or using magnetic separators of varying strength to provide ferrous slurries of varying ferrous content.

### BACKGROUND

Steel mill sludge is material generated during the process of steelmaking that contains iron oxide. Steel mill sludge, also referred to simply as “mill sludge,” is generally distinguished from mill scale by its finer particle size and higher oil content. During the steelmaking process, and particularly during processing after the blast furnace, generate streams typically containing waste water, iron oxide based solids, oil and other hydrocarbon compounds. These streams are typically collected in a settling pit in which the stream separates into three phases, typically an upper oil phase or layer comprising the lighter free hydrocarbons, an aqueous layer or phase below the oil phase and a lower layer or phase comprising the mill sludge and mill scale

The oil contamination present in the mill sludge is generally derived from the lubricants and coolants used in manufacturing the final steel products as well as lubricants from the process equipment that is exposed to elevated temperatures during the formation of the final steel products. This oil contamination throughout the mill sludge limits the potential for recycling the iron oxide containing sludge back into the steelmaking process. The heat involved in the steelmaking process liberates hydrocarbons and various oxides of hydrocarbons from oily substances, creating air contamination and making it difficult to meet environmental quality standards. In addition, if the material recycled to the sinter plant (which prepares the feed to the blast furnaces) contains too much oil, operational problems such as fouled fan blades and filter bags result, in addition to the problem of excessive hydrocarbon emissions.

As in many industries, the management of wastes generated by steel manufacturing has become an important issue due to ever-tightening environmental regulations. Historically, the slag, dust, and sludge generated by steel manufacturing was considered “waste” and simply transferred to landfills, pits and other disposal venues. With the need for reducing emissions and improving efficiency, those materials that were once simply “waste” are now “by-products” that are the subject of intensive amelioration and re-utilization efforts. A steel plant typically generates about 900 pounds of solid waste per ton of steel produced, consisting mainly of slag, dust, and sludge. A major portion of the waste is reused in sintering plants. However waste that has a high content of hydrocarbons must be de-oiled prior to reclaiming the iron content for reuse in order to reduce emissions and carbon fouling issues.

Numerous patents and patent applications disclose various techniques, compositions and processes for dealing with various aspects of de-oiling sludge. The de-oiling processes incorporating the teachings of these patents were partially effective—that is, oil was removed in amounts sufficient to meet the environmental standards of the day, but these prior art processes are generally unable to attain the high environmental standards required today. While conventional “de-oiled” materials could include as much as 10 wt % oil (100,000 parts per million), in order to meet current environmental standards, recovered de-oiled solids that are to be reclaimed must contain less than 2,000 parts per million oil, or less than 0.2 wt % oil. As a result of the more stringent environmental requirements, the conventional processes are not currently in widespread use, leaving major steel companies with hundreds of thousands of tons of sludge that is stockpiled awaiting treatment or expensive disposal in a landfill. These stockpiles represent a valuable resource because the sludge can contain 50 dry wt % (dwt %) or more iron.

One reason that the conventional prior art processes are unable to attain or have difficulty attaining the very low levels of de-oiling required under the newer regulations is attributed to the nature of the mill sludge itself. In particular, the mill sludge solids are characterized by particles having very fine diameters, typically on the order of that associated with fine silts and clays. The very small particles allow the oil molecules to form extremely tight bonds with the solid particles and/or within agglomerations of such particles. Conventional processes provide for the application of a range of surfactants, shearing forces, and dewatering devices to reclaim the solids. However, even repeated cycling of sludge through such conventional processes are typically unable to reduce the oil content of the mill sludge to the required level of less than 2,000 parts per million.

Representative prior art includes U.S. Pat. Nos. 3,844,943; 4,091,826; 4,177,062; 4,288,329; 4,326,883; 4,585,475; 4,738,785; 4,995,912; 5,047,083, 5,125,966 and 7,531,046, the contents of which are hereby incorporated by reference in their entirety.

U.S. Pat. No. 7,531,046, for example, discloses a process for treating an oily mixture consisting of hydrocarbons, solid particles, and water which includes the steps of placing the oily mixture into a reactor chamber, purging the reactor chamber with an inert gas, and creating a steam bath within the inert gas filled reactor chamber, the steam surge freeing hydrocarbon matter from the solid particles. The process further includes elevating reactor chamber temperature to a boiling point temperature corresponding to the hydrocarbons in the oily mixture, the elevated temperature vaporizing the hydrocarbons are vaporized within inert atmosphere. The reaction chamber is vented and the off-gas is processed into a hydrocarbon product while the de-oiled solid particles are discharged from the reaction chamber as a raw material or for disposal.

U.S. Pat. No. 5,125,966, for example, discloses a process for de-oiling mill sludge which comprises admixing the mill sludge with sufficient water and sufficient surface active agent to provide a slurry having at least 25 wt % solids content and at least 4,000 ppm of surface active agent based on solids, subjecting the slurry to high shear agitation to form an oily water emulsion, and separating at least 40 wt % of the solids from the oily water emulsion. As an example of these minimum parameters, from 100 parts by weight of a slurry containing 25 wt % solids (25 parts by weight solids), at minimum 10 parts by weight solids (40 wt % of the solids) would be separated from the oily water emulsion by the process. As disclosed, it was contemplated that the process for de-oiling mill sludge would further involve subjecting the mill sludge to process, and then repeating the process steps on the solids recovered from the oily water emulsion until such time as the oil content of the recovered solids has been reduced to the desired degree.

### SUMMARY OF THE INVENTION

Disclosed is a method for treating oil-containing particulates such as mill sludge comprising applying a treatment solution to a particulate feed stream to form a treated slurry, applying a mechanical disrupter to the treated slurry to reduce an average particulate size, applying a magnetic separator to the treated slurry to form a ferrous slurry, and applying a thermal separator to the ferrous slurry to extract a hydrocarbon portion and produce a ferrous product stream. This basic method may be modified in a number of ways including, for example, applying a sizing operation to the oil-containing particulates to remove larger particles from the particulate feed stream, condensing a volume of the hydrocarbon portion or using magnetic separators of varying strength to provide ferrous slurries of varying ferrous content.

As will be appreciated, a range of treatment solutions can be utilized including, for example, solutions comprising a petroleum based softening agent, an emollient, a solubilizer and a coupling agent. These components may be present in varying quantities encompassing, for example, treatment solutions including 20 and 70 wt % of a petroleum based softening agent, 2 and 50 wt % of an emollient, 5 to 25 wt % of a solubilizer and 1 and 10 wt % of a coupling agent. The emollient may be a pH neutral emollient, but other embodiments of the treatment solution may include non-neutral emollients and/or pH adjusters and buffering agents.

The petroleum based softening agent may include one or more hydrocarbon fuel composition(s), the emollient may include one or more glycols, the solubilizer may include one or more ethers and alcohols and the coupling agent may include one or more organic acids. An example treatment solution is one in which the petroleum based softening agent comprises diesel fuel, the emollient comprises polypropylene glycol, the solubilizer includes at least one compound selected from a group consisting of polyoxyethelene ether and polyoxyethelene alcohol, and the coupling agent comprises dicarboxylic acid.

As detailed below and in the accompanying FIGURES, the disclosure also encompasses apparatus suitable for practicing the disclosed methods comprising an assembly of sizing, conveying, spraying, disrupting, separating, heating and condensing equipment arranged to perform the sequence of operations required to complete the method.

### BRIEF DESCRIPTION OF THE DRAWINGS

Example embodiments described below will be more clearly understood when the detailed description is considered in conjunction with the accompanying drawings, in which:

FIG. 1 illustrates an example sludge preparation process and a corresponding example sludge preparation apparatus.

FIG. 2 illustrates an example separation and recovery process and a corresponding example separation and recovery apparatus.

It should be noted that these Figures are intended to illustrate the general characteristics of methods, structure and/or materials utilized in the example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION OF THE DISCLOSURE

The process and related apparatus disclosed herein provide an integrated industrial process that can be utilized for de-oiling steel industry and other oil-contaminated wastes to less than 2,000 ppm oil content. This process and apparatus enables the reclamation and recycling into the steel manufacturing process of an increased proportion of the iron content of the sludge which may exceed 50 dwt % (dry weight percent). The process is applicable to both unstabilized sludge and to sludge that has previously been treated and/or stabilized through, for example, the addition of 10 to 20 dwt % lime and/or other compounds.

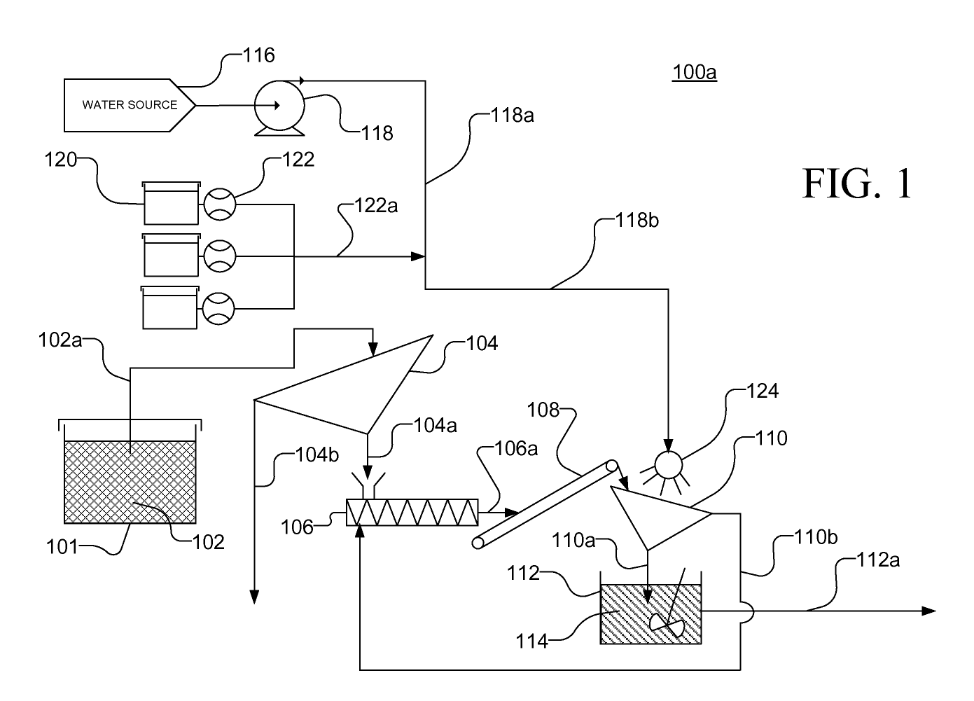

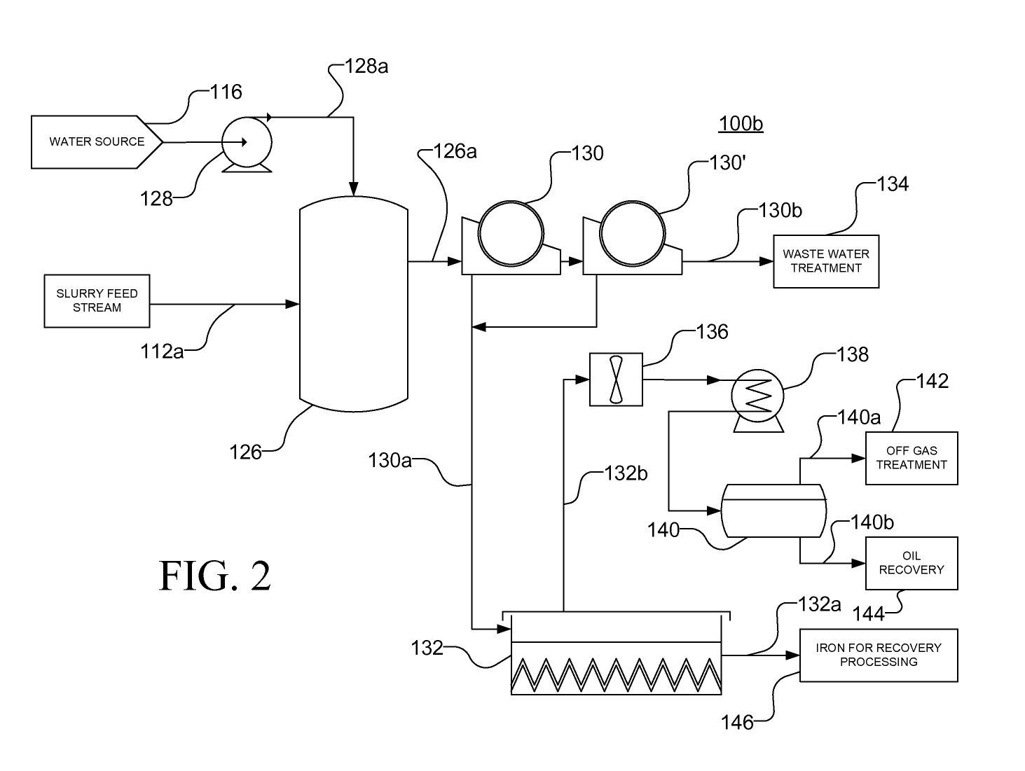

An example process and an example apparatus are illustrated in FIGS. 1 and 2 with a sludge preparation apparatus and method shown with respect to apparatus 100a of FIG. 1 and the separation and recovery apparatus and method shown with respect to apparatus 100b of FIG. 2. As illustrated, mill sludge or stabilized mill sludge 102 is withdrawn from a settling pond, reservoir, tank or other storage facility 101 and fed 102a to one or more scalping screen(s) 104 or other suitable separating device for removing oversized debris 104b, for example, those particles greater than 4 inches in diameter (10.2 cm). As will be appreciated, the selection of the particular size classification and sorting technique(s) will be guided by a number of factors including, for example, the average particle size in the mill sludge, the particle size distribution and the capability of the downstream separation processes.

That portion of the sludge feed 104a that passes through the screen 104 can then be fed into a crusher or mill 106 to further reduce the size of the particles for additional processing. The crushed sludge stream 106a can then be transferred via conveyor 108 to a second screen or other separator 110 to ensure that the remaining particles approach a suitable target size, for example, no more than 0.5 inch in diameter (1.3 cm). Those particles in the crushed sludge stream 106a that are still above the target size for further processing can be feed back to the crusher through a recycle stream 110b or discarded.

A washing system, typically including a pump 118, washing chemical reservoir(s) 120 for a wetting agent chemical, an emollient chemical, a solubilizing chemical, and a coupling agent chemical, water source(s) 116, and metering pump(s) 122 capable of metering concentrations of, for example, up to 2.0 percent or more may be used for injecting the treatment chemicals 122a into a water feed 118a to produce a washing solution 118b. This washing solution is then sprayed 124 on the sludge as it passes over the screen 110 and/or injected into a slurry mixing tank 112. In the slurry mixing tank the screened sludge and the washing solution are combined and agitated to form a slurry 114 containing, for example, 35 wt % solids.

The slurry stream 112a is then pumped to a physical separator 126 for further processing. The physical separator 126 may, for example, operate on the venturi principal using high pressure fluid 128a, for example, water at 5,000 to 10,000 psi (344 to 689 bar), supplied by high pressure pump 128 to produce high speed water jets or streams and/or other mechanical and/or ultrasonic processes (not shown) known to those of ordinary skill in the art sufficient to reduce remaining aggregations of fine sludge particles to smaller aggregations and individual particles and form a processed slurry stream 126a. As will be appreciated, the selection of the particular separation technique(s) will be guided by a number of factors including, for example, the average particle size, the particle size distribution, the degree of agglomeration and the distribution of agglomeration degree within the slurry stream.

The processed slurry stream 126a from physical separator 126 is then transferred to one or more wet drum magnetic separators 130, 130′ configured for removing those particulates having a sufficiently high concentration iron and/or other magnetic metal from the processed slurry. The removed particulates 130a, the “solid” phase, can then be subjected to further treatment in order to de-oil the separated solids. The “liquid” phase exiting the magnetic separator 130b typically includes water, oil and non-magnetic compounds not removed in the separators including, for example, graphite that may be treated using conventional wastewater treatment methods 134.

The solid phase 130a exiting the magnetic separator consists generally of magnetic sludge containing iron and other metals still having some oil content. The magnetic sludge is transported to a low temperature extractor 132 operating at 600-800° F. (316 to 427° C.). As the magnetic sludge passes through the extractor 132, a portion of the oil remaining in the magnetic sludge is extracted to produce de-oiled sludge 132a exhibiting an oil content of less than 2,000 ppm (mg/kg). The de-oiled sludge 132a is suitable for recovery 146 and reuse of its iron content.

The gas exhaust 132b from the low temperature extractor contains the separated oil, lighter organics and entrained water. The exhaust may be withdrawn from the extractor 132 by a blower 136 that moves the exhaust through a condenser 138.

In the condenser 138, oil separates from the exhaust. The exhaust and oil flow to a receiver tank 140. From the receiver tank 140, oil 140b is extracted for recovery processing 144 and the exhaust 140a can be directed to suitable off-gas treatment equipment 142.

The invention can be constructed in different ways as long as the function performed by the equipment is achieved. For example, multiple wet drum magnetic separators 130, 130′ may be used depending on the nature of the iron particles in the sludge. Differing gauss strengths, and hence different wet drum separators, may be required to remove differing sizes of iron particles. As will be appreciated by those skilled in the art, because a wide range of crushing and screening equipment and processes can be adapted to produce a suitable slurry stream, the disclosure is not limited to the particular example embodiment illustrated and described herein.

An example washing or treatment solution suitable for injection at 124 is a composition including a petroleum based softening agent, for example, diesel fuel, comprising between 20 and 70 wt %; an emollient, preferably a pH neutral emollient, for example, polypropylene glycol, comprising between 2 and 50 wt %; a solubilizer, for example, polyoxyethelene ether and/or polyoxyethelene alcohol, comprising between 5 to 25 wt %; and a coupling agent, for example, dicarboxylic acid, comprising between 1 and 10 wt %. As will be appreciated, if the emollient(s) selected are not pH neutral, the treatment solution may also contain pH adjuster(s) and/or buffering agents for controlling the pH of the solution. It is anticipated that in most instances a generally neutral pH will be sufficient but, depending on the nature and composition of the feed slurry, the pH of the treatment solution may be adjusted in order to achieve improved oil release and/or control the pH of the treated slurry solution that will be fed into the downstream processes.

As will be appreciated, the various components of the washing solution can be handled separately and/or in one or more compositions, e.g., master batch formulation(s), to provide a wider range of compositions and/or simplify the process control respectively. The components of the washing solution have the combined effect of loosening the chemical bonds between oil and the solid particles and helping to mobilize the oil in preparation for disaggregation of the sludge particles in the physical separator 126.

Those skilled in the art will also appreciate that the sludge preparation process and separation and recovery process and apparatus, i.e., the front end and back end of a unified process and corresponding apparatus may be further modified for particular applications by taking into consideration such factors as the type of sludge, the hydrocarbon loading level and composition and the intended use of the processed sludge. Those of ordinary skill in the art will appreciate that the equipment and process fluids may be adapted to the particular demands and requirements of a particular application.

While the invention has been particularly shown and described with reference to certain example embodiments thereof, it will be understood by those of ordinary skill in the art that various changes in form and details may be made therein without departing from the spirit and scope of the invention as defined by the following claims.

I claim:

1. A method for treating oil-containing particulates comprising:
applying a treatment solution to a particulate feed stream to form a treated slurry;
applying a mechanical disrupter to the treated slurry to reduce an average particulate size;
applying a magnetic separator to the treated slurry to form a ferrous slurry; and
applying a thermal separator to the ferrous slurry to extract a hydrocarbon portion and produce a ferrous product stream.

2. The method for treating oil-containing particulates according to claim 1, further comprising:
applying a sizing operation to the oil-containing particulates to remove larger particles from the particulate feed stream.

3. The method for treating oil-containing particulates according to claim 1, further comprising:
condensing a volume of the hydrocarbon portion.

4. The method for treating oil-containing particulates according to claim 1, wherein:
the treatment solution comprises
a petroleum based softening agent;
an emollient;
a solubilizer; and
a coupling agent.

5. The method for treating oil-containing particulates according to claim 4, wherein:
the treatment solution comprises
20 and 70 wt % of a petroleum based softening agent;
2 and 50 wt % of an emollient;
5 to 25 wt % of a solubilizer; and
1 and 10 wt % of a coupling agent.

6. The method for treating oil-containing particulates according to claim 4, wherein:
the emollient is a pH neutral emollient.

7. The method for treating oil-containing particulates according to claim 4, wherein:
the treatment solution further comprises a compound selected from a group consisting of pH adjusters and buffering agents.

8. The method for treating oil-containing particulates according to claim 5, wherein:
the emollient is a pH neutral emollient.

9. The method for treating oil-containing particulates according to claim 5, wherein:
the treatment solution further comprises a compound selected from a group consisting of pH adjusters and buffering agents.

10. The method for treating oil-containing particulates according to claim 4, wherein:
the petroleum based softening agent comprises a hydrocarbon fuel composition;
the emollient comprises a glycol;
the solubilizer includes at least one compound selected from a group consisting of ethers and alcohols; and
the coupling agent comprises an organic acid.

11. The method for treating oil-containing particulates according to claim 4, wherein:
the petroleum based softening agent comprises diesel fuel;
the emollient comprises polypropylene glycol;
the solubilizer includes at least one compound selected from a group consisting of polyoxyethelene ether and polyoxyethelene alcohol; and
the coupling agent comprises dicarboxylic acid.

12. The method for treating oil-containing particulates according to claim 1, wherein:
the mechanical disrupter comprises impacting the treated slurry with a high-pressure fluid jet sufficient to reduce aggregations and agglomerations within the treated slurry.

13. The method for treating oil-containing particulates according to claim 1, wherein:
the mechanical disrupter comprises impacting the treated slurry with ultrasonic energy of a magnitude sufficient to reduce aggregations and agglomerations within the treated slurry.

14. An apparatus for treating oil-containing particulates comprising:
a sprayer configured for applying a treatment solution to a particulate feed stream to form a treated slurry;
a mechanical disrupter configured for receiving and disrupting the treated slurry to reduce an average particulate size within the treated slurry;
a magnetic separator configured for removing a magnetic portion of the treated slurry to form a ferrous slurry; and
a thermal separator configured for heating the ferrous slurry to a temperature sufficient to volatilize and remove a hydrocarbon portion from the ferrous slurry.

15. The apparatus for treating oil-containing particulates according to claim 14, further comprising:
sizing equipment configured for separating larger particulates from the oil-containing particulates.

16. The apparatus for treating oil-containing particulates according to claim 14, wherein:
the mechanical disrupter applies jets of a working solution to the treated slurry at a pressure of 5,000 to 10,000 psi (344 to 689 bar).
